(19) United States
(12) Patent Application Publication
(10) Pub. No.: US 2013/0154146 A1
(43) Pub. Date: Jun. 20, 2013

(54) SINTERING MACHINE AND METHOD OF MANUFACTURING SINTERED BODY

(71) Applicant: SONY CORPORATION, Tokyo (JP)

(72) Inventors: Kiwamu Adachi, Kanagawa (JP); Shusaku Yanagawa, Kanagawa (JP)

(73) Assignee: SONY CORPORATION, Tokyo (JP)

(21) Appl. No.: 13/690,816

(22) Filed: Nov. 30, 2012

(30) Foreign Application Priority Data
Dec. 20, 2011 (JP) 2011-278267

(51) Int. Cl. B29C 67/04

(52) U.S. Cl. CPC B29C 67/04
USPC 264/40.3; 264/40.1; 425/170; 425/174.8 R; 425/446

(57) ABSTRACT

A sintering machine includes: a die configured to accommodate a processing object, and having a hole that extends from an outer side surface of the die toward inside of the die; a pressurizing member configured to apply a pressure on the processing object in the die; and a heating section configured to heat the processing object in the die.

### BACKGROUND

The present disclosure relates to a sintering machine that puts a processing object in a die to calcinate the processing object through pressurization and heating (hot press), and a method of manufacturing a sintered body using such a sintering machine.

A hot press machine (pressurization heating furnace) puts a processing object in a die (dice or mold) to heat such a processing object while applying pressure thereon using a pressurizing member (punch). Methods for a hot press machine are classified into several types, and, as one of the classified methods, there are a sealed type (closed type) that performs a pressurization heating in a vacuum or inert gas atmosphere and an open type that performs a pressurization heating in an atmospheric air. When calcination in an oxidizing or inert gas atmosphere is necessary, the sealed type is often used. Further, the sealed type is also employed to prevent a dice from being consumed due to oxidation because a carbon is used as a material of a dice in many cases. On the contrary, the open type permits the progression of consumption of a dice due to oxygen in an atmospheric air, although this type achieves high productivity because it is possible to carry out replacement of a dice, that is, a processing object which has been calcined, and the like at the same time as calcination is completed.

As a heating method for a hot press machine, an indirect heating using an external heater is generally used in many cases (for example, see Japanese Patent No. 2797576 (FIG. 1)). When a material to be calcined is conductive, a punch conducting type may be used in some cases (for example, see Japanese Patent No. 4163394 (FIG. 1)). Further, the open type also has a method that performs induction heating of an outer circumferential area of a dice using a high-frequency induction coil.

In temperature control of a processing object in a hot press machine, it has been difficult to directly measure temperature of a processing object within a dice since a dice serves as an isobaric vessel. Accordingly, a method has been adopted that measures temperature on an outer surface of a dice or atmospheric temperature between a dice and an external heater using a thermocouple or a radiation thermometer to control the measured temperature. Further, in case of the conducting heating method described in Japanese Patent No. 4163394, a method has been adopted that measures temperature on side surfaces of spacers mounted above and below a punch using a radiation thermometer.

### SUMMARY

In case of the open type, however, a disadvantage has taken place that an outer surface of a dice deteriorates due to oxidation, resulting in the temperature measurement being unstable. This involves a process to clean a surface of a dice as appropriate during heating, which forces heating to be interrupted frequently.

It is to be noted that, for reference's sake, Japanese Patent No. 4427846 describes that there is also a case where it is possible to use a sheathed thermocouple instead of a radiation thermometer. However, when high-frequency induction heating is adopted as a heating method for example, high-frequency waves are superimposed on a thermocouple, which makes it difficult to use a sheathed thermocouple.

It is desirable to provide a sintering machine that reduces the influence of a change in quality of an outer surface of a die, thereby allowing a stable temperature measurement to be performed, and a method of manufacturing a sintered body using such a sintering machine.

A sintering machine according to an embodiment of the present disclosure includes: a die configured to accommodate a processing object, and having a hole that extends from an outer side surface of the die toward inside of the die; a pressurizing member configured to apply a pressure on the processing object in the die; and a heating section configured to heat the processing object in the die.

In the sintering machine according to the above-described embodiment of the present disclosure, the processing object in the die is pressurized by the pressurizing member, while being heated by the heating section. In this machine, the hole is provided in a direction from the outer side surface of the die toward the inside of the die, which allows a temperature on an end surface in an innermost recess of the hole to be measured.

A method of manufacturing a sintered body according to an embodiment of the present disclosure allows a processing object to be accommodated in a die and sinters the processing object by application of a pressure and heating of the processing object in the die. The method includes: measuring a first temperature on an end surface in an innermost recess of a hole that extends from an outer side surface of the die toward inside of the die. A method of manufacturing a sintered body according to another embodiment of the present disclosure allows a processing object to be accommodated in a die and sinters the processing object by application of a pressure and heating of the processing object in the die. The method includes: preparing a first sensor; and measuring, using the first sensor, a first temperature on an end surface in an innermost recess of a hole that extends from an outer side surface of the die toward inside of the die.

In the method of manufacturing the sintered body according to each of the above-described embodiments of the present disclosure, the hole is provided in a direction from the outer side surface of the die toward the inside of the die, and the first temperature on the end surface in the innermost recess of the hole is measured. Therefore, unlike an existing method in which a temperature on an outer surface of a die or an atmospheric temperature between the die and an external heater is measured, it is possible to reduce the influence of a change in quality of an outer surface of the die, thereby allowing a stable temperature measurement to be performed.

In the sintering machine according to the above-described embodiment of the present disclosure, the hole is provided in a direction from the outer side surface of the die toward the inside of the die, which allows the method of manufacturing the sintered body according to each of the above-described embodiments of the present disclosure to be readily carried out.

It is to be understood that both the foregoing general description and the following detailed description are exemplary, and are intended to provide further explanation of the technology as claimed.

### BRIEF DESCRIPTION OF THE DRAWINGS

The accompanying drawings are included to provide a further understanding of the present disclosure, and are incorporated in and constitute a part of this specification. The drawings illustrate embodiments and, together with the specification, serve to explain the principles of the present technology.

FIG. 1 is a cross-sectional view showing a configuration of a sintering machine according to a first embodiment of the present disclosure.

FIG. 2 is a plan view showing a configuration viewed from above for the sintering machine illustrated in FIG. 1.

FIG. 3 is a cross-sectional view for explaining an existing temperature measurement method.

FIG. 4 is a diagram for explaining an issue involved in the existing temperature measurement method illustrated in FIG. 3.

FIG. 5 is a diagram showing a state of second temperature in the case where first temperature was measured and controlled in comparison with a case where temperature on an outer surface of a dice was measured and controlled.

FIG. 6 is a cross-sectional view for explaining measurement of second temperature in the sintering machine illustrated in FIG. 1.

FIG. 7 is a diagram showing a state of second temperature from a point of time when first temperature reached a target value as a starting point in the case where the first temperature was measured and controlled in comparison with a case where temperature on an outer surface of a dice was measured and controlled.

FIG. 8 is a diagram showing a state of second temperature in raising first temperature to approximately 1300 degrees centigrade in the case where the first temperature was measured and controlled.

FIG. 9 is a cross-sectional view showing a configuration of a sintering machine according to a second embodiment of the present disclosure.

### DETAILED DESCRIPTION

Hereinafter, some embodiments of the present disclosure are described in details with reference to the drawings. It is to be noted that the descriptions are provided in the order given below.
1. First embodiment (example where a hole proceeding from an outer side surface of a die toward the inside is provided)
2. Second embodiment (example where a hole is provided at a position different from a processing object in a height direction of a die)

### First Embodiment

### (Sintering Machine)

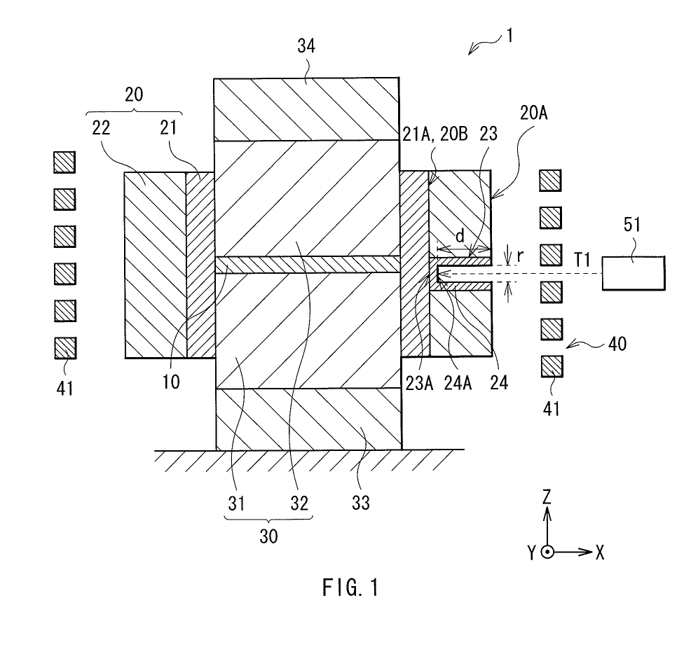

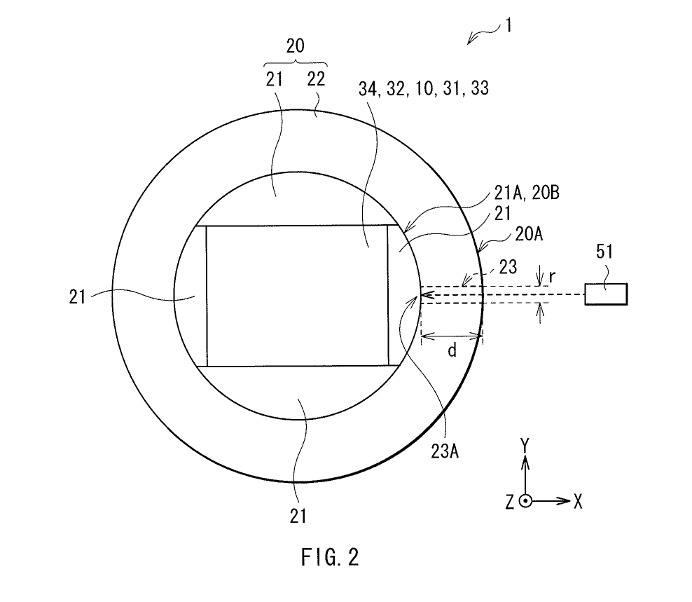

FIG. 1 shows a cross-sectional configuration of a sintering machine according to a first embodiment of the present disclosure, and FIG. 2 shows a planar configuration viewed from above for the sintering machine illustrated in FIG. 1. This sintering machine 1 is a uniaxial hot press machine including: a die 20 configured to accommodate a processing object 10, that is, powder to be sintered; a punch (pressurizing member) 30 configured to apply pressure on the processing object 10 within the die 20; and a heating section 40 configured to heat the processing object 10 within the die 20. The processing object 10 is, for example, powder that is a raw material for a sputtering target of a ceramic-based material, or a calcined material (sintered body) thereof.

The die 20 has, for example, an insert dice (inner die) 21 configured to define a planar shape of the processing object 10 in a dice (outer die) 22. The dice 22, which is a cylindrical member for example, serves as an isobaric vessel to keep a pressure applied by the punch 30 in containment. The insert dice 21 is composed of a combination of a plurality of members that are fitted into the dice 22 in an attachable-removable manner, and types of various shapes and dimensions are available in accordance with shapes and dimensions of the processing object 10. The insert dice 21 and the dice 22 are composed of carbon for example.

The punch 30 has a lower punch 31 and an upper punch 32 that are fitted into the insert dice 21 of the die 20, and the processing object 10 is interposed between these punches to be pressurized in a vertical direction (z-axis direction in FIG. 1 and FIG. 2). The lower punch 31 and the upper punch 32 are composed of, for example, carbon just like the die 20. The lower punch 31 is placed on a pedestal 33. On the upper punch 32, there is provided a pressure ram 34.

The heating section 40 has, for example, a high-frequency induction coil 41 for induction heating of an outer side surface 20A of the dice 22 on the die 20. In other words, the sintering machine 1 is an open type hot press machine of an atmospheric calcination induction heating method.

In the sintering machine 1, a hole 23 for temperature measurement is provided in a direction from the outer side surface 20A of the die 20 toward the inside. Consequently, in the sintering machine 1, by measuring first temperature T1 on an end surface 23A in the innermost recess of this hole 23 using a sensor such as a radiation thermometer 51, it is possible to reduce the influence of a change in quality of an outer surface of the die 20, thereby allowing a stable temperature measurement to be performed.

In other words, it is desirable to make a temperature measurement at a location closer to the processing object 10, although it is difficult to make a fixed-point measurement of members movable by additional pressure, such as the punch 30 and the insert dice 21. Further, for an open type hot press machine, a state of the top face or peripheral area on the outer side surface 20A of the dice 22 varies due to oxidation, and thus a more stable measuring location is necessary. For such a reason, it is desirable that the hole 23 be bored on the dice 22, and a temperature measurement be made inside the die 20 and at a location closest to the insert dice 21. More specifically, it is preferable that the hole 23 be provided to allow temperature on an outer side surface 21A of the insert dice 21 that is exposed in the hole 23 to be measured. However, when the hole 23 is provided in a pressure direction (z-axis direction) with respect to the dice 22, a length (depth) of the hole 23 increases, which brings a disadvantage in the strength. Further, because many structures are present in a vertical direction of the dice 22, a structure such as a reflecting mirror and the like for refracting a measuring optical axis path is necessary during a measurement using the radiation thermometer 51. As a result, it is likely that a machine configuration will be complicated, and an issue of the measurement accuracy may also occur. Accordingly, it is advantageous from any viewpoints of simplified machine configuration, retained strength of the dice 22, and improved temperature measurement accuracy to provide the hole 23 at a part of a thickness direction of the die 20 in a direction (diameter direction of the die 20) vertical (or substantially vertical) to a pressure direction (z-axis direction) from the outer side surface 20A of the die 20 toward a center thereof.

In concrete terms, it is preferable that the hole 23 be provided from the outer side surface 20A to an inner side surface 20B of the dice 22. In other words, it is preferable that the hole 23 go right through the dice 22, although it be not communicated with the dice 22 and the insert dice 21. This is because it is likely that the processing object 10 may be taken out of the hole 23 in association with application of pressure when the hole 23 goes right through the die 20 completely. Further, as another reason, when the hole 23 is communicated with the dice 22 and the insert dice 21, it is likely that the hole 23 inside the dice 22 and the hole 23 inside the insert dice 21 may be out of alignment during application of pressure.

It is to be noted that a position of the hole 23 in a circumferential direction is not specified in particular, although the hole is preferably provided at a relatively thicker position on the insert dice 21 for example.

Further, the sintering machine 1 has a closed-end tube 24 having a closed-end surface 24A at a first end with a second end open. The closed-end tube 24 is fitted into the hole 23 with the closed-end surface 24A brought into contact with the outer side surface 21A of the insert dice 21. One reason thereof is as follows. For a sealed type, sintering is performed in a vacuum or inert gas, and thus it is possible to measure the first temperature T1 on the end surface 23A in the innermost recess of the hole 23 using the radiation thermometer 51. On the contrary, for an open type, it is likely that an outermost circumferential portion (vicinity of an inlet) of the hole 23 will be enlarged due to an air atmosphere every time sintering is performed, or the hole 23 itself may be enlarged. Fitting of the closed-end tube 24 into the hole 23 prevents the inside of the hole 23 from deteriorating due to oxidation, thereby allowing a long-term stable temperature measurement to be carried out.

It is preferable that a ratio of a diameter r to a depth (length) d of the hole 23 or the closed-end tube 24 be generally not less than 1:10 for example. This allows the inside of the hole 23 or the closed-end tube 24 to be regarded as a pseudo blackbody cavity, which makes it possible to improve the absolute value accuracy in the temperature measurement. It is to be noted that a diameter r and a depth d in FIG. 1 and FIG. 2 are denoted as the diameter r and the depth d of the closed-end tube 24.

It is preferable that such a closed-end tube 24 be composed of any material with the oxidation resistance. In concrete terms, examples of constituent materials for the closed-end tube 24 include, without limitation, aluminum oxide (alumina), zirconium oxide (zirconia), hafnium oxide (hafnia) or composite materials thereof (such as sialon and cordierite), and silicon carbide. Further, any material that coats or covers carbon graphite with the above-described materials may be also permitted.

For example, the sintering machine 1 may be manufactured in the following manner.

First, a measuring distance from the radiation thermometer 51 to the outer side surface 21A of the insert dice 21 is set up to determine a size of the closed-end tube 24. Hereupon, the measuring distance is set to approximately 1 m for example. For example, when the IR-SAS11N available from Chino Corporation located in Tokyo-to, Japan, is used for the radiation thermometer 51, a measuring area becomes approximately φ10 mm. In consideration of a few area margin from this result, a recrystallized alumina protective tube PT-0 (available from Sanko Electric Co., Ltd. located in Osaka-fu, Japan) with an inner diameter of φ13 mm and an outer diameter of φ17 mm is selected.

Next, the hole 23 passing through the dice 22 in a diameter direction is provided on the outer side surface 20A of the dice 22. For the dice 22, insert dice 21, lower punch 31, and upper punch 32, it is preferable that isotropic carbon be selected as a material from a viewpoint of the durability, thermal conductivity, and the like.

When the hole 23 is provided on the dice 22, it is preferable to consider an interference of the dice 22 with the closed-end tube 24 due to thermal expansion. If the closed-end tube 24 is greater than the dice 22 in the coefficient of thermal expansion, it is advantageous to bore the hole 23 that is oversized by just that much.

Assuming that the coefficient of thermal expansion of the closed-end tube 24 made of alumina as described above is approximately 7.6 ppm/degree centigrade, and a sintering temperature range is up to approximately 1300 degrees centigrade, the hole 23 expands by approximately 0.17 mm in a diameter direction in using a simplified bulk conversion. Accordingly, a margin of approximately 0.2 mm is set up to form the hole 23 of approximately φ17.2 mm. For formation of the hole 23, a hole may be bored on the typical dice 22 with a drill or the like, although a through-hole may be provided beforehand in forming the dice 22 alternatively. It is preferable that a length of the closed-end tube 24 be basically equivalent to a thickness of the dice 22, although when sintering is performed with the top surface of the dice 22 covered with a heat-insulating material, the closed-end tube 24 may be made longer by a thickness of such a heat-insulating material.

It is to be noted that the design of the closed-end tube 24 and the hole 23 is allowed to be set up optimally in accordance with a distance between a measuring point and the radiation thermometer 51 as well as the specifications of the radiation thermometer 51.

The closed-end tube 24 is inserted into the hole 23 of the dice 22 that is formed in such a manner. These steps complete the sintering machine 1 illustrated in FIG. 1 and FIG. 2.

### (Method of Manufacturing a Sintered Body)

Next, the description is provided on a method of manufacturing a sintered body using the sintering machine 1. More specifically, the processing object 10, that is, powder to be sintered is accommodated into the die 20, and then the processing object 10 is interposed between the lower punch 31 and the upper punch 32 to apply pressure thereon. Subsequently, a current is applied to the high-frequency induction coil 41 to start induction heating to the outer side surface 20A of the die 20. A temperature rising rate may be approximately 5 degrees centigrade/min, and after a target temperature is reached, control is performed to keep this temperature.

At this time, the first temperature T1 on the end surface 23A in the innermost recess of the hole 23 (closed-end surface 24A inside the closed-end tube 24 when the closed-end tube 24 is fitted into the hole 23) is measured using the radiation thermometer 51. Further, a high-frequency current to be applied to the high-frequency induction coil 41 is adjusted on the basis of the measurement result, thereby controlling the first temperature T1. By controlling a current to be applied to the high-frequency induction coil 41 in a closed loop in such a manner, the influence of a state or degree of consumption of the outer side surface 20A on the die 20, and the like is reduced, which makes it possible to perform a stable temperature measurement as well as to carry out a temperature control of the processing object 10 with high stability and excellent repeatability.

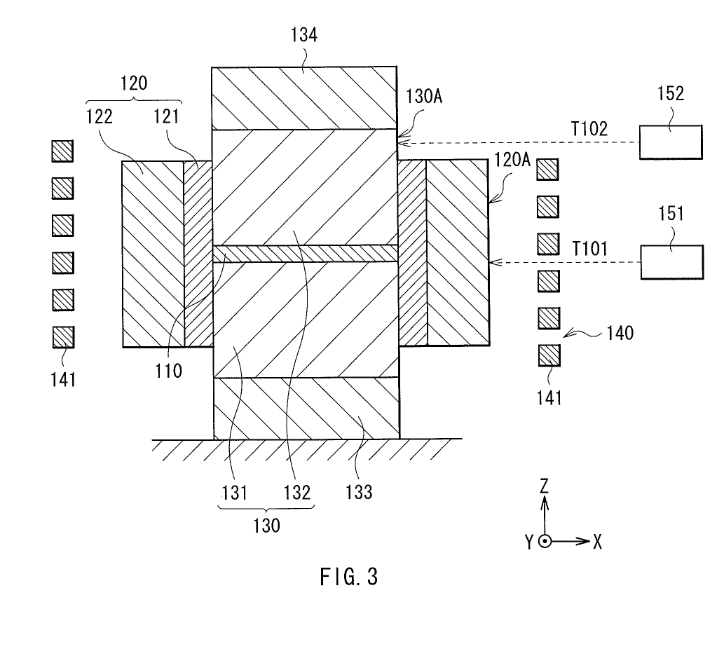

On the contrary, in the past, as shown in FIG. 3 for example, temperature T101 on an outer top surface 120A of a dice 122 is measured, and thus for an open type, the outer top surface 120A of the dice 122 deteriorates due to oxidation, resulting in the temperature measurement being unstable. This involves a process to clean the outer top surface 120A of the dice 122 as appropriate during heating, which forces heating to be interrupted frequently. It is to be noted that, in FIG. 3, the same component parts as those shown in FIG. 1 and FIG. 2 are denoted with the same reference numerals plus one hundred.

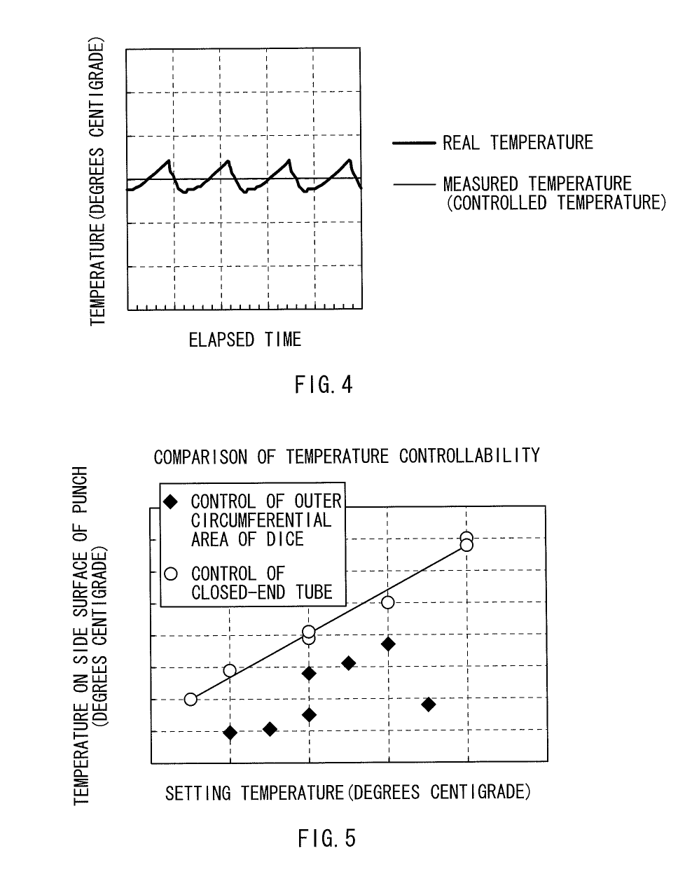

FIG. 4 shows a result of a measurement that was performed on the temperature T101 on the outer top surface 120A of the dice 122 using the existing temperature measurement method illustrated in FIG. 3. As seen from FIG. 4, because a state of the top surface on the dice 122 is different immediately before and after a cleaning process, real temperature was in the sawtooth form when a control was attempted to keep temperature for indication at a constant value. It is to be noted that a temperature measurement method using a sheathed thermocouple which is described in Japanese Patent No. 4427846 is not adoptable in the case where the induction heating method, as in the present embodiment and the example illustrated in FIG. 3, is adopted.

Further, in this embodiment of the present disclosure, the first temperature T1 on the end surface 23A in the innermost recess of the hole 23 (closed-end surface 24A inside the closed-end tube 24 when the closed-end tube 24 is fitted into the hole 23) is measured using the radiation thermometer 51, which allows a temperature rising control to be performed on the basis of a temperature measurement result of a location closer to the processing object 10. As a result, the rising characteristics of internal temperature of the die 20 are improved in comparison with the existing method to measure temperature on the outer top surface 120A of the dice 122 as shown in FIG. 3. This allows the first temperature T1 to reach setting temperature or saturation temperature faster.

Additionally, heating of an outer circumferential area of the dice 22 through the high-frequency induction depends on an eddy-current depth of penetration that is represented by Expression 1 given below.

δ=5.03×√(ρ/μf) (Expression 1)

(In the above expression, δ is a current depth of penetration, ρ is a resistivity of the dice 22, μ is a relative magnetic permeability, and f is a frequency.)

Accordingly, as oxidation on the outer side surface 20A of the dice 22 progresses, ρ in Expression 1 varies in a diameter direction of the dice 22, causing an internal progress of a heating location to arise. This has brought a disadvantage that internal temperature, that is, real temperature is higher than the temperature measured with the radiation thermometer 51 on the outer side surface 20A of the dice 22.

To deal with this issue, every effort has been made to perform calcination as reproducibly as possible based on experience or control of the number of times in the past, although it is difficult to meet the calcination demanding strict temperature and time control, giving rise to variations in finishing of products.

On the contrary, in this embodiment of the present disclosure, the first temperature T1 on the end surface 23A in the innermost recess of the hole 23 (closed-end surface 24A inside the closed-end tube 24 when the closed-end tube 24 is fitted into the hole 23) is measured using the radiation thermometer 51. Consequently, even if a high-frequency induction heating method is adopted for the heating section 40, it is possible to carry out a stable and high-accuracy temperature measurement that reflects internal temperature of the die 20 more precisely without being influenced by the internal progress of a heating location due to a change in quality of the outer side surface 20A of the dice 22.

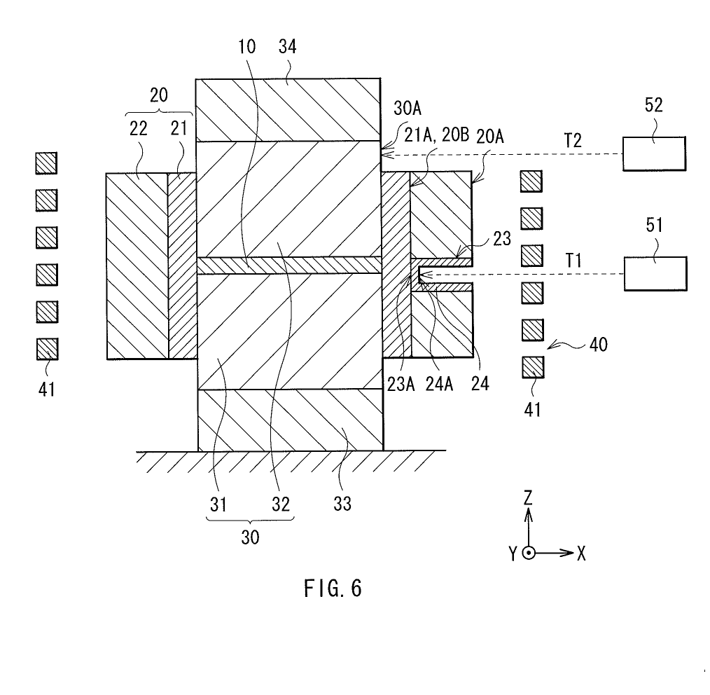

FIG. 5 shows a result of a measurement that was performed on second temperature T2 on a side surface 30A of the upper punch 32 by the use of a radiation thermometer 52 as illustrated in FIG. 6 (white circle mark in FIG. 5: control of closed-end tube) in parallel with measurement and control of the first temperature T1 in the above-described manner. In addition, FIG. 5 also shows a result of a measurement that was performed on temperature T102 on a side surface 130A of an upper punch 132 by the use of a radiation thermometer 152 (black rhombus mark in FIG. 5: control of outer circumferential area of the dice) in parallel with measurement and control of temperature T101 on an outer top surface 120A of a die 120 as illustrated in FIG. 3. It is to be noted that a scale marking in a vertical line indicates higher temperature as it moves upwards in FIG. 5, and one scale is equivalent to approximately 10 degrees centigrade. A scale marking in a horizontal line indicates higher temperature as it moves to the right side, and one scale is equivalent to approximately 20 degrees centigrade.

As seen from FIG. 5, when measurement and control of the temperature T101 on the outer top surface 120A of the die 120 were carried out, a variation in temperature increased so much that finding a correlation between setting temperature on the outer top surface 120A of the die 120 and the temperature T102 on the side surface 130A of the upper punch 132 was difficult. On the contrary, when measurement and control of the first temperature T1 on the closed-end surface 24A inside the closed-end tube 24 were carried out, a correlation between setting temperature for the first temperature T1 and the second temperature T2 on the side surface 30A of the upper punch 32 is obtained.

Further, when measurement and control of the first temperature T1 on the closed-end surface 24A inside the closed-end tube 24 were carried out, temperature measuring values were generally higher compared with a case where measurement and control of the temperature T101 on the outer top surface 120A of the die 120 were carried out. This is a result showing that temperature at a location closer to the inside of the dice 22 was measured and controlled when measurement and control of the first temperature T1 on the closed-end surface 24A inside the closed-end tube 24 were carried out.

In other words, it is found that if the hole 23 proceeding from the outer side surface 20A of the die 20 toward the inside is provided, and the first temperature T1 on the end surface 23A in the innermost recess of the hole 23 is measured using the radiation thermometer 51, this makes it possible to reduce the influence of a state or a degree of consumption on the outer side surface 20A of the die 20 and to perform a stable temperature measurement, as well as to measure temperature at a location closer to the processing object 10.

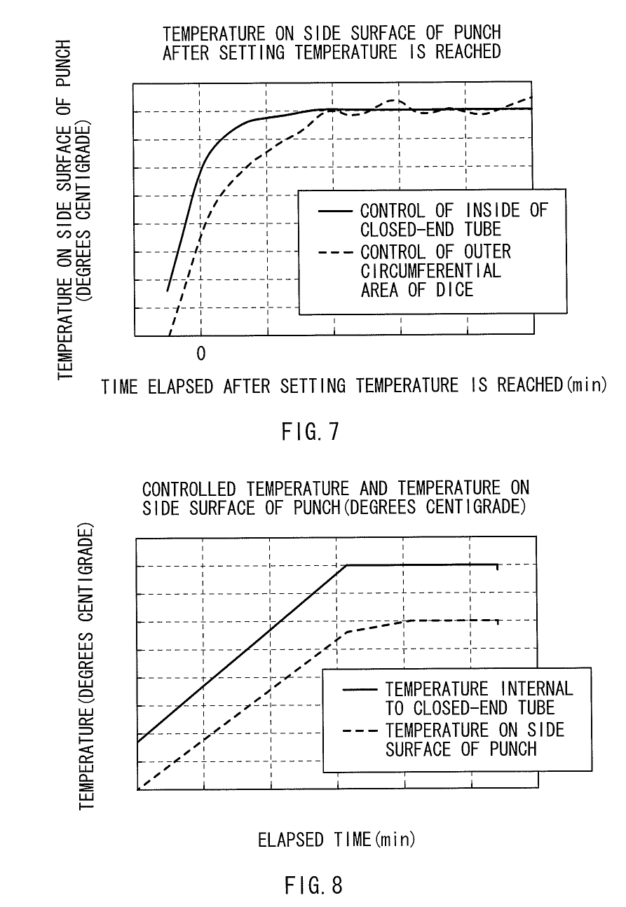

FIG. 7 shows a result of a measurement that was performed on the second temperature T2 on the side surface 30A of the upper punch 32 by the use of the radiation thermometer 52 from a point of time when the first temperature T1 reached a target value (setting temperature) as a starting point (solid line in FIG. 7: control of the inside of the closed-end tube). Further, FIG. 7 also shows a result of a measurement that was performed on the temperature T102 on the side surface 130A of the upper punch 132 by the use of the radiation thermometer 152 from a point of time when the temperature T101 on the outer top surface 120A of the die 120 reached a target value (setting temperature) as a starting point (dotted line in FIG. 7: control of the outer circumferential area of the dice). It is to be noted that a scale marking in a vertical line indicates higher temperature as it moves upwards in FIG. 7, and one scale is equivalent to approximately 10 degrees centigrade. A scale marking in a horizontal line indicates a time elapsed as it moves from the left to the right side, and one scale is equivalent to approximately 20 minutes with a time when the first temperature T1 or the temperature T101 on the outer top surface 120A of the die 120 reached a target value (setting temperature) defined as 0.

As seen from FIG. 7, when measurement and control of the first temperature T1 on the closed-end surface 24A inside the closed-end tube 24 were carried out, the second temperature T2 on the side surface 30A of the upper punch 32, that is, internal temperature rose quickly, and further was maintained at a constant value once it reached an equilibrium state. This is presumably because the temperature stability is improved without being influenced by a state of the top face on the outer side surface 20A of the die 20.

On the other hand, when measurement and control of the temperature T101 on the outer top surface 120A of the die 120 were carried out, the temperature T102 on the side surface 130A of the upper punch 132 rose slowly, and a pulsation was found even after the saturation temperature was reached. This pulsation occurs due to the same cause of a sawtooth-like temperature variation that is described with reference to FIG. 3 and FIG. 4.

In other words, it is found that if the hole 23 proceeding from the outer side surface 20A of the die 20 toward the inside is provided, and the first temperature T1 on the end surface 23A in the innermost recess of the hole 23 is measured using the radiation thermometer 51, this makes it possible to enhance the controllability and stability of temperature and to improve an increase in temperature at the inside of the die, that is, a location closer to the processing object 10, which contributes to reduction of a sintering time.

In addition, in this embodiment of the present disclosure, as shown in FIG. 6, it is preferable that the second temperature T2 on the side surface 30A of the punch 30 be measured using a sensor such as the radiation thermometer 52 to control pressurization and heating of the processing object 10 on the basis of a measurement result of the first temperature T1 and the second temperature T2. In concrete terms, after the first temperature T1 reaches a target value, it is preferable to perform additional application of pressure onto the processing object 10, or count starting of a sintering time, or both of them in a state where the second temperature T2 is saturated. This makes it possible to improve the uniformity in temperature internal to the processing object 10.

Hereupon, as shown in FIG. 6, it is possible to measure the second temperature T2 on the side surface 30A of the punch 30, or alternatively it is also possible to measure the second temperature T2 on the top face or bottom face of the die 20 (more specifically, the insert dice 21).

In other words, a general issue in the case of heating from an outer circumferential area of the dice 22 includes a temperature distribution in a diameter direction. This is a phenomenon caused by the thermal conductivity and thermal capacity, and in many cases in the past, proper conditions have been derived in such a manner that confirmation of conditions is performed repeatedly to obtain an optimum calcination result according to a material being calcined or calcination amount, size, and shape, and the rising speed of temperature, waiting time until repressurization, and the like are adjusted. In addition, like Japanese Patent No. 2797576 as described above, there have been also instances where modeling is carried out based on basic data utilizing advanced computing to determine optimum conditions. However, any methods have a disadvantage of being time-consuming.

In the course of continued studies, disclosing parties of the present technology have found that a changing state of the top surface temperature on the punch 30 or the insert dice 21 is available as an index indicating a temperature state of the internal processing object 10. It is thought that the punch 30 comes in contact with the processing object 10 directly, or indirectly in some cases to reflect a temperature state of the processing object 10. Moreover, there is a correlation between the temperature on the side surface 30A of the punch 30 and the first temperature T1 (see FIG. 5). Based on these matters, it is possible to monitor the temperature on the side surface 30A of the punch 30 or the second temperature T2 on the top face or bottom face of the insert dice 21 as a similar location, for performing calcination based on the monitored temperature state.

In concrete terms, when the heat storage and heat radiation of the dice 22, the insert dice 21, the punch 30, and the like are put in an equilibrium state under a certain condition, the top surface temperature on the punch 30 or the insert dice 21 is put in an equilibrium state.

An absolute value of the second temperature T2 on the side surface 30A of the punch 30, or on the top face or bottom face of the die 20 (more specifically, the insert dice 21) varies depending on a material being sintered that is the processing object 10, loading amount thereof, and thermal capacity of the punch 30 and the die 20 even if heating temperature is constant, although a variation in temperature that is caused by the saturation in thermal balance is approximately constant.

Based on this fact, as shown in FIG. 6, in addition to measurement and control of the first temperature T1 as described above, the radiation thermometer 52 for measuring the second temperature T2 on the side surface 30A of the punch 30 is added, and measurement and control of the first temperature T1 and monitoring of the second temperature T2 are carried out together, and thereafter determination of timing for additional application of pressure (repressurization) or count starting of a sintering time, or both of them are carried out from a point of time when the second temperature T2 is saturated as a basing point. This eliminates the necessity of carrying out repeated confirmation of conditions or advanced computing, and resolves an issue of a temperature distribution in a diameter direction as described above, allowing the uniformity of temperature internal to the processing object 10 to be improved.

FIG. 8 shows a result of a measurement that was performed on the second temperature T2 on the side surface 30A of the upper punch 32 by the use of the radiation thermometer 52 (dotted line in FIG. 8: temperature on the side surface of the punch) along with a result of increasing the first temperature T1 up to predetermined temperature through measurement and control of the first temperature T1 as described above (solid line in FIG. 8: temperature internal to the closed-end tube). It is to be noted that a scale marking in a vertical line indicates higher temperature as it moves upwards in FIG. 8, and one scale is equivalent to approximately 50 degrees centigrade. A scale marking in a horizontal line indicates a time elapsed as it moves from the left to the right side, and one scale is equivalent to approximately 20 minutes.

It is seen from FIG. 8 that the second temperature T2 was saturated after a delay of approximately 20 minutes when the first temperature T1 reached a setting value of approximately 1300 degrees centigrade. The temperature saturation on the side surface 30A of the upper punch 32 indicates that heating to the processing object 10 and heat radiation from the upper punch 32 are balanced, and this is allowed to be regarded as a temperature saturation state in this system. From a point of time when such a thermal balance is achieved as a trigger, additional application of pressure or count starting of a sintering time, or both of them are carried out, which allows the sintering with superior reproducibility of temperature distribution to be performed.

In FIG. 8 for example, after approximately 10 minutes for example when the thermal balance is achieved in consideration of a margin and the like, additional application of pressure or count starting of a sintering time, or both of them may be carried out, which allows the sintering with superior reproducibility of temperature distribution to be performed. It is to be noted that the temperature distribution is not completely removed.

As described above, the processing object 10 is sintered to form a sintered body in such a manner that the processing object 10 inside the die 20 is heated using the high-frequency induction coil 41 of the heating section 40 and is pressurized with the punch 30.

As described above, in this embodiment of the present disclosure, the first temperature T1 on the end surface 23A in the innermost recess of the hole 23 proceeding from the outer side surface 20A of the die 20 toward the inside is measured using the radiation thermometer 51, and thus it is possible to obtain advantageous effects given below without limitation.
(1) It is possible to reduce the influence of a state or a degree of consumption on the outer top surface of the die 20, allowing a stable temperature measurement to be performed. This makes it possible to carry out a temperature control of the processing object 10 with high stability and superior reproducibility.
(2) A cleaning process for the outer side surface 20A of the die 20 is unnecessary, eliminating the necessity of interrupting heating.
(3) It is possible to perform a temperature rising control on the basis of a temperature measurement result of a location closer to the processing object 10, resulting in the rising characteristics of temperature internal to the die 20 being improved. This allows the first temperature T1 to reach setting temperature or saturation temperature thereof faster, which makes it possible to improve the temperature rising characteristics of the processing object 10.
(4) Even when a high-frequency induction heating method is adopted for the heating section 40, it is possible to perform a temperature measurement with high stability and high accuracy reflecting the internal temperature of the die 20 more precisely without being influenced by internal progress of a heating location that is caused by a change in quality on the outer side surface 20A of the dice 22.

Further, in this embodiment of the present disclosure, the second temperature T2 on the side surface 30A of the punch 30, or on the top face or bottom face of the die 20 (more specifically, the insert dice 21) is measured using the radiation thermometer 52 to control the pressurization and heating of the processing object 10 on the basis of a measurement result of the first temperature T1 and the second temperature T2. In concrete terms, after the first temperature T1 reaches a target value, additional application of pressure onto the processing object 10, or count starting of a sintering time, or both of them are carried out in a state where the second temperature T2 is saturated. This eliminates the necessity of carrying out repeated confirmation of conditions or advanced computing, and resolves an issue of a temperature distribution in a diameter direction, allowing the uniformity of temperature internal to the processing object 10 to be improved.

In addition, the closed-end tube 24 having the closed-end surface 24A at a first end is fitted into the hole 23 with the closed-end surface 24A brought into contact with the outer side surface 21A of the insert dice 21, which prevents the inside of the hole 23 from deteriorating due to oxidation, thereby allowing a long-term stable temperature measurement to be carried out.

### Second Embodiment

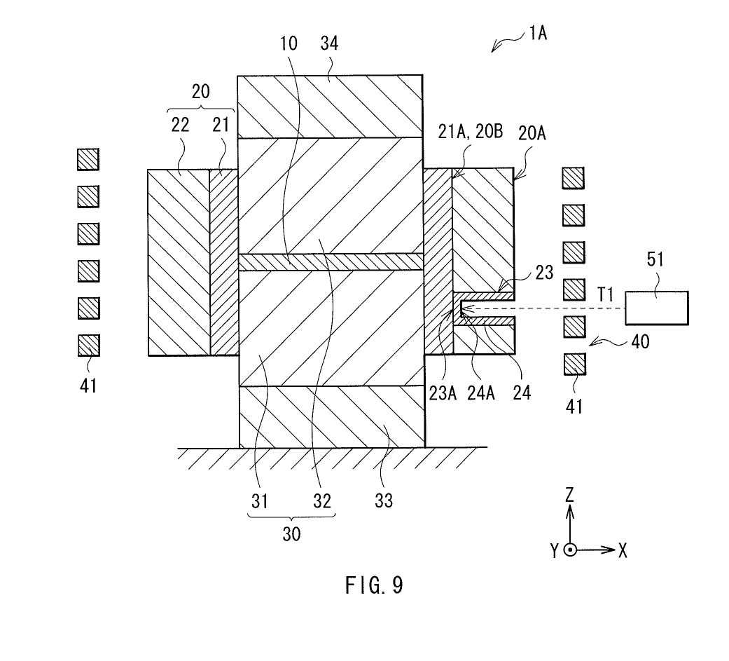

FIG. 9 shows a cross-sectional configuration of a sintering machine 1A according to a second embodiment of the present disclosure. The sintering machine 1A has the same configuration, operation, and advantageous effects as those in the above-described first embodiment with the exception that the hole 23 is provided at a position different from an accommodating position of the processing object 10 in a height direction (z-axis direction) of the die 20 when the processing object 10 is accommodated in the die 20. For the same component parts, therefore, the descriptions are omitted as appropriate.

As described above, when the processing object 10 is accommodated in the die 20, the hole 23 is provided at a position shifted from an accommodating position of the processing object 10 in a height direction (z-axis direction) of the die 20. In other words, the hole 23 is provided to prevent it from being present on an extending line in a diameter direction of the accommodating position of the processing object 10. This is because a result from a stress simulation showed that stresses exerted on the insert dice 21 and the dice 22 during sintering of the processing object 10 concentrated on the outward in a diameter direction of the processing object 10. Providing the hole 23 at a position different from the accommodating position of the processing object 10 in the z-axis direction allows to prevent a stress from the processing object 10 from being exerted directly on the hole 23.

It is to be noted that the hole 23 may be provided below (at lower position) the accommodating position of the processing object 10 in the z-axis direction as shown in FIG. 6, or may be provided above (at upper position) the accommodating position of the processing object 10 in the z-axis direction (not shown in the figure).

A method of manufacturing a sintered body using the sintering machine 1A is the same as that in the above-described first embodiment.

As described above, in this embodiment of the present disclosure, when the processing object 10 is accommodated in the die 20, the hole 23 is provided at a position different from the accommodating position of the processing object 10 in a height direction of the die 20, which allows to prevent a stress from the processing object 10 from being exerted directly on the hole 23 at the time of sintering.

The present disclosure is described hitherto with reference to the above-described embodiments, although the present disclosure is not limited thereto, but various modifications are available. For example, in the above-described embodiments, the description is provided on a case where the loading amount of the processing object 10 is in a single stage, although the present disclosure is not limited to a case where the processing object 10 is loaded in a single stage, but is also applicable to a case where the processing object 10 is loaded in a plurality of stages. In this case, a position of the hole 23 in the second embodiment may be changed in accordance with a loading position or a spacing interval of the processing object 10.

Further, in the above-described embodiments, the description is provided on a case where the lower punch 31 and the upper punch 32 come in direct contact with the processing object 10, although carbon paper, spacer (plate), or the like that may be composed of a same material may be interposed between the processing object 10 and the lower punch 31 or the upper punch 32.

Moreover, in the above-described embodiments, the description is provided on a case where a measurement of the second temperature T2 is performed on the side surface 30A of the punch 30 or other position, although a member with high thermal conductivity and enhanced strength (not shown in the figure) may be inserted between the punch 30 and the pressure ram 34, thereby measuring temperature on the side surface of this member.

Additionally, for example, in the above-described embodiments, the description is provided with specific reference to configurations of the sintering machines 1 and 1A, although it is not necessary to provide all the component parts, or any other component parts may be further provided.

The present disclosure is especially advantageous for, but not limited to, a sintering machine for a sputtering target of a ceramic-based material and a method of manufacturing a sintered body using such a sintering machine, and a target material is not limited.

Accordingly, it is possible to achieve at least the following configurations from the above-described example embodiments and the modifications of the disclosure.
(1) A sintering machine, including:

a die configured to accommodate a processing object, and having a hole that extends from an outer side surface of the die toward inside of the die;

a pressurizing member configured to apply a pressure on the processing object in the die; and

a heating section configured to heat the processing object in the die.
(2) The sintering machine according to (1), wherein the hole is provided at a position that is different from an accommodating position of the processing object in a height direction of the die when the processing object is accommodated in the die.
(3) The sintering machine according to (1) or (2), wherein

the die includes an outer die and an inner die provided in the outer die, the inner die being configured to define a planar shape of the processing object, and

the hole is provided from an outer side surface, serving as the outer side surface of the die, of the outer die to an inner side surface of the outer die.
(4) The sintering machine according to (3), wherein the hole is provided to allow a temperature on an outer side surface of the inner die that is exposed in the hole to be measured.
(5) The sintering machine according to (3) or (4), further including a closed-end tube having a closed-end surface at one end thereof, the closed-end tube being fitted into the hole with the closed-end surface brought into contact with an outer side surface of the inner die.
(6) The sintering machine according to (5), wherein a ratio of a diameter to a depth of the hole or the closed-end tube is not less than 1:10.
(7) The sintering machine according to (5) or (6), wherein the closed-end tube is made of a material selected from the group consisting of: aluminum oxide; zirconium oxide; hafnium oxide; a composite material of any combination of the aluminum oxide, the zirconium oxide, and the hafnium oxide; silicon carbide; and a material coating or covering carbon graphite with the aluminum oxide, the zirconium oxide, the hafnium oxide, the composite material, or the silicon carbide.
(8) The sintering machine according to any one of (1) to (7), wherein the heating section includes a high-frequency induction coil that performs induction heating of the outer side surface of the die.
(9) A method of manufacturing a sintered body, the method allowing a processing object to be accommodated in a die and sintering the processing object by application of a pressure and heating of the processing object in the die, the method including:

measuring a first temperature on an end surface in an innermost recess of a hole that extends from an outer side surface of the die toward inside of the die.
(10) The method of manufacturing the sintered body according to (9), wherein

the die includes an outer die and an inner die provided in the outer die, the inner die being configured to define a planar shape of the processing object, and

the hole is provided from an outer side surface, serving as the outer side surface of the die, of the outer die to an inner side surface of the outer die.
(11) The method of manufacturing the sintered body according to (10), wherein the hole is provided to allow the first temperature on an outer side surface of the inner die that is exposed in the hole to be measured.
(12) The method of manufacturing the sintered body according to (10) or (11), wherein

a closed-end tube having a closed-end surface at one end thereof is fitted into the hole with the closed-end surface brought into contact with an outer side surface of the inner die, and

a temperature on the closed-end surface is measured as the first temperature.
(13) The method of manufacturing the sintered body according to any one of (9) to (12), further including:

measuring a second temperature on a side surface of a pressurizing member configured to apply the pressure to the processing object in the die, or on a top face or a bottom face of the die; and

controlling the application of the pressure, the heating, or both of the application of the pressure and the heating of the processing object based on a measurement result of the first temperature and the second temperature.
(14) The method of manufacturing the sintered body according to (13), further including performing, after the first temperature reaches a target value, additional application of pressure onto the processing object, count starting of a sintering time, or both of the additional application of pressure and the count starting in a state where the second temperature is saturated.
(15) The method of manufacturing the sintered body according to any one of (9) to (14), wherein the hole is provided at a position that is different from an accommodating position of the processing object in a height direction of the die when the processing object is accommodated in the die.
(16) A method of manufacturing a sintered body, the method allowing a processing object to be accommodated in a die and sintering the processing object by application of a pressure and heating of the processing object in the die, the method including:

preparing a first sensor; and

measuring, using the first sensor, a first temperature on an end surface in an innermost recess of a hole that extends from an outer side surface of the die toward inside of the die.
(17) The method of manufacturing the sintered body according to (16), wherein

the die includes an outer die and an inner die provided in the outer die, the inner die being configured to define a planar shape of the processing object, and

the hole is provided from an outer side surface, serving as the outer side surface of the die, of the outer die to an inner side surface of the outer die.
(18) The method of manufacturing the sintered body according to (17), wherein the hole is provided to allow the first temperature on an outer side surface of the inner die that is exposed in the hole to be measured.
(19) The method of manufacturing the sintered body according to (17) or (18), wherein

a closed-end tube having a closed-end surface at one end thereof is fitted into the hole with the closed-end surface brought into contact with an outer side surface of the inner die, and

a temperature on the closed-end surface is measured as the first temperature.
(20) The method of manufacturing the sintered body according to any one of (16) to (19), further including:

preparing a second sensor;

measuring, using the second sensor, a second temperature on a side surface of a pressurizing member configured to apply the pressure to the processing object in the die, or on a top face or a bottom face of the die; and

controlling the application of the pressure, the heating, or both of the application of the pressure and the heating of the processing object based on a measurement result of the first temperature and the second temperature.
(21) The method of manufacturing the sintered body according to (20), further including performing, after the first temperature reaches a target value, additional application of pressure onto the processing object, count starting of a sintering time, or both of the additional application of pressure and the count starting in a state where the second temperature is saturated.
(22) The method of manufacturing the sintered body according to any one of (16) to (21), wherein the hole is provided at a position that is different from an accommodating position of the processing object in a height direction of the die when the processing object is accommodated in the die.

The present disclosure contains subject matter related to that disclosed in Japanese Priority Patent Application JP 2011-278267 filed in the Japan Patent Office on Dec. 20, 2011, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A sintering machine, comprising:
a die configured to accommodate a processing object, and having a hole that extends from an outer side surface of the die toward inside of the die;
a pressurizing member configured to apply a pressure on the processing object in the die; and
a heating section configured to heat the processing object in the die.

2. The sintering machine according to claim 1, wherein the hole is provided at a position that is different from an accommodating position of the processing object in a height direction of the die when the processing object is accommodated in the die.

3. The sintering machine according to claim 1, wherein
the die includes an outer die and an inner die provided in the outer die, the inner die being configured to define a planar shape of the processing object, and
the hole is provided from an outer side surface, serving as the outer side surface of the die, of the outer die to an inner side surface of the outer die.

4. The sintering machine according to claim 3, wherein the hole is provided to allow a temperature on an outer side surface of the inner die that is exposed in the hole to be measured.

5. The sintering machine according to claim 3, further comprising a closed-end tube having a closed-end surface at one end thereof, the closed-end tube being fitted into the hole with the closed-end surface brought into contact with an outer side surface of the inner die.

6. The sintering machine according to claim 5, wherein a ratio of a diameter to a depth of the hole or the closed-end tube is not less than 1:10.

7. The sintering machine according to claim 5, wherein the closed-end tube is made of a material selected from the group consisting of: aluminum oxide; zirconium oxide; hafnium oxide; a composite material of any combination of the aluminum oxide, the zirconium oxide, and the hafnium oxide; silicon carbide; and a material coating or covering carbon graphite with the aluminum oxide, the zirconium oxide, the hafnium oxide, the composite material, or the silicon carbide.

8. The sintering machine according to claim 1, wherein the heating section includes a high-frequency induction coil that performs induction heating of the outer side surface of the die.

9. A method of manufacturing a sintered body, the method allowing a processing object to be accommodated in a die and sintering the processing object by application of a pressure and heating of the processing object in the die, the method comprising:
measuring a first temperature on an end surface in an innermost recess of a hole that extends from an outer side surface of the die toward inside of the die.

10. The method of manufacturing the sintered body according to claim 9, wherein
the die includes an outer die and an inner die provided in the outer die, the inner die being configured to define a planar shape of the processing object, and
the hole is provided from an outer side surface, serving as the outer side surface of the die, of the outer die to an inner side surface of the outer die.

11. The method of manufacturing the sintered body according to claim 10, wherein the hole is provided to allow the first temperature on an outer side surface of the inner die that is exposed in the hole to be measured.

12. The method of manufacturing the sintered body according to claim 10, wherein a closed-end tube having a closed-end surface at one end thereof is fitted into the hole with the closed-end surface brought into contact with an outer side surface of the inner die, and
a temperature on the closed-end surface is measured as the first temperature.

13. The method of manufacturing the sintered body according to claim 9, further comprising:
measuring a second temperature on a side surface of a pressurizing member configured to apply the pressure to the processing object in the die, or on a top face or a bottom face of the die; and
controlling the application of the pressure, the heating, or both of the application of the pressure and the heating of the processing object based on a measurement result of the first temperature and the second temperature.

14. The method of manufacturing the sintered body according to claim 13, further comprising performing, after the first temperature reaches a target value, additional application of pressure onto the processing object, count starting of a sintering time, or both of the additional application of pressure and the count starting in a state where the second temperature is saturated.

15. The method of manufacturing the sintered body according to claim 9, wherein the hole is provided at a position that is different from an accommodating position of the processing object in a height direction of the die when the processing object is accommodated in the die.

16. A method of manufacturing a sintered body, the method allowing a processing object to be accommodated in a die and sintering the processing object by application of a pressure and heating of the processing object in the die, the method comprising:
preparing a first sensor; and
measuring, using the first sensor, a first temperature on an end surface in an innermost recess of a hole that extends from an outer side surface of the die toward inside of the die.

17. The method of manufacturing the sintered body according to claim 16, wherein
the die includes an outer die and an inner die provided in the outer die, the inner die being configured to define a planar shape of the processing object, and
the hole is provided from an outer side surface, serving as the outer side surface of the die, of the outer die to an inner side surface of the outer die.

18. The method of manufacturing the sintered body according to claim 17, wherein the hole is provided to allow the first temperature on an outer side surface of the inner die that is exposed in the hole to be measured.

19. The method of manufacturing the sintered body according to claim 17, wherein
a closed-end tube having a closed-end surface at one end thereof is fitted into the hole with the closed-end surface brought into contact with an outer side surface of the inner die, and
a temperature on the closed-end surface is measured as the first temperature.

20. The method of manufacturing the sintered body according to claim 16, further comprising:
preparing a second sensor;
measuring, using the second sensor, a second temperature on a side surface of a pressurizing member configured to apply the pressure to the processing object in the die, or on a top face or a bottom face of the die; and
controlling the application of the pressure, the heating, or both of the application of the pressure and the heating of the processing object based on a measurement result of the first temperature and the second temperature.
